(19) United States
(12) Patent Application Publication
(10) Pub. No.: US 2019/0057135 A1
(43) Pub. Date: Feb. 21, 2019

(54) Visualization of a State of a Data Item

(71) Applicant: Connect Financial LLC, Wellesley, MA (US)

(72) Inventors: Jennifer Hillary Elizabeth Wyon, Belmont, MA (US); Rachael Thomas Acker, West Roxbury, MA (US); Joshua Matthew Eaker, West Roxbury, MA (US); Emily Joy Mills, Brookline, MA (US)

(73) Assignee: Connect Financial LLC, Wellesley, MA (US)

(21) Appl. No.: 15/681,462

(22) Filed: Aug. 21, 2017

(51) Int. Cl. G06F 17/30; G06F 3/0481; G06F 3/0482

(52) U.S. Cl. CPC G06F 17/30554; G06F 3/0482; G06F 3/04812

(57) ABSTRACT

Among other things, a value of a data item is calculated. The data item has possible values that correspond to degrees of a user-related condition. The calculation is based on information about the user-related condition for a user. A metaphorical element is presented to the user that metaphorically represents a degree of the user-related condition corresponding to the value of the data item. The metaphorical element belongs to a set of metaphorical elements that are related and metaphorically represent different respective degrees of the user-related condition, a new value of the data item is calculated in response to a change in the user-related condition. In response to the new value, a different one of the metaphorical elements is presented to the user. The change from one to another of the metaphorical elements metaphorically represents the change in the user-related condition.

### BACKGROUND

This description relates to visualization of a state of the data item.

User interfaces often convey overview information about underlying data (for example, numerical data) using visualization techniques. A graph or a pie chart, for example, can provide a visual representation of numerical data that is sometimes more intuitive and easier for users to grasp than the numbers. As values of the underlying data change, the graph or pie chart can be updated, and users can understand the changes in the values graphically without having to think about the numbers in their raw form.

Icons are often presented in user interfaces to graphically stand for concepts such as places, people, products, or contexts. Sometimes, two different related icons can be displayed at different times to represent changes. For example, two different icons can show a telephone “handset” in two different states, an on-hook state and an off-hook state. A user can then recognize whether the handset is on-hook or off-hook without having to read and mentally process words such as “on hook” or “off hook” and can quickly understand when the hook state of the handset has changed.

In a common technique for presenting changing values of data, graphical elements of a user interface can be set up to undergo corresponding changes only when the underlying data values change by more than a certain amount. For example, a smart phone may calculate a value representing an amount of battery charge remaining. That underlying data value could have, for example, any integer value between zero and 100. For presentation to a user, a graphical battery charge indicator may have only, say, five different states showing how much battery charge remains. Only when the calculated underlying value changes by more than, for example, 20 points, will the graphical state of the battery charge indicator be changed on the display screen of a smart phone.

### SUMMARY

In general, in an aspect of the technology that we describe here, a value of a data item is calculated. The data item has possible values that correspond to degrees of a user-related condition. The calculation is based on information about the user-related condition of a particular user. A metaphorical element is presented to the user that metaphorically represents a degree of the user-related condition corresponding to the value of the data item. The metaphorical element belongs to a set of metaphorical elements that are related and metaphorically represent different respective degrees of the user-related condition. A new value of the data item is calculated in response to a change in the user-related condition. In response to the new value, a different one of the metaphorical elements is presented to the user. The change from one to another of the metaphorical elements metaphorically represents the change in the user-related condition.

In some implementations of the general aspect, one or a combination of two or more of the following features may be present. The user-related condition includes a financial condition. The financial condition includes at least one of insurance protection, available cash, cash flow, or debt. The number of possible values of the data item is larger than the number of metaphorical elements. Each of the metaphorical elements is associated with a set of the possible values of the data item. The metaphorical elements include graphical elements. The metaphorical elements include audible elements. The metaphorical elements of the set correspond to different conditions of a metaphorical object. The metaphorical object includes at least one of a line hung between two supports, a cocktail umbrella, a balance scale, and a jar of water. The different conditions of the metaphorical object include the shape of the object, the location of the object, or the orientation of the object. The set of metaphorical elements include different presentations of a single graphical element. The single graphical element includes at least one of a line hung between two supports, a cocktail umbrella, a balance scale, and a jar of water. The change from one to another of the metaphorical element is animated.

In general, in an aspect, a processor is configured to calculate a value of a data item, the data item having possible values that correspond to degrees of a user-related condition. The calculation is based on information about the user-related condition for a user. A presenting device is configured to present to the user a metaphorical element that metaphorically represents a degree of the user-related condition corresponding to the value of the data item. The metaphorical element belongs to a set of metaphorical elements that are related and metaphorically represent different respective degrees of the user-related condition. The processor is configured to calculate a new value of the data item in response to a change in the user-related condition for the user. The presenting device is configured to present to the user a different one of the metaphorical elements in response to the new value. The change from one to another of the metaphorical elements metaphorically represents the change in the user-related condition.

These and other aspects, features, and implementations can be expressed as methods, apparatus, systems, components, program products, methods of doing business, means or steps for performing a function, and in other ways.

These and other aspects, features, and implementations will become apparent from the following descriptions, including the claims.

### DESCRIPTION

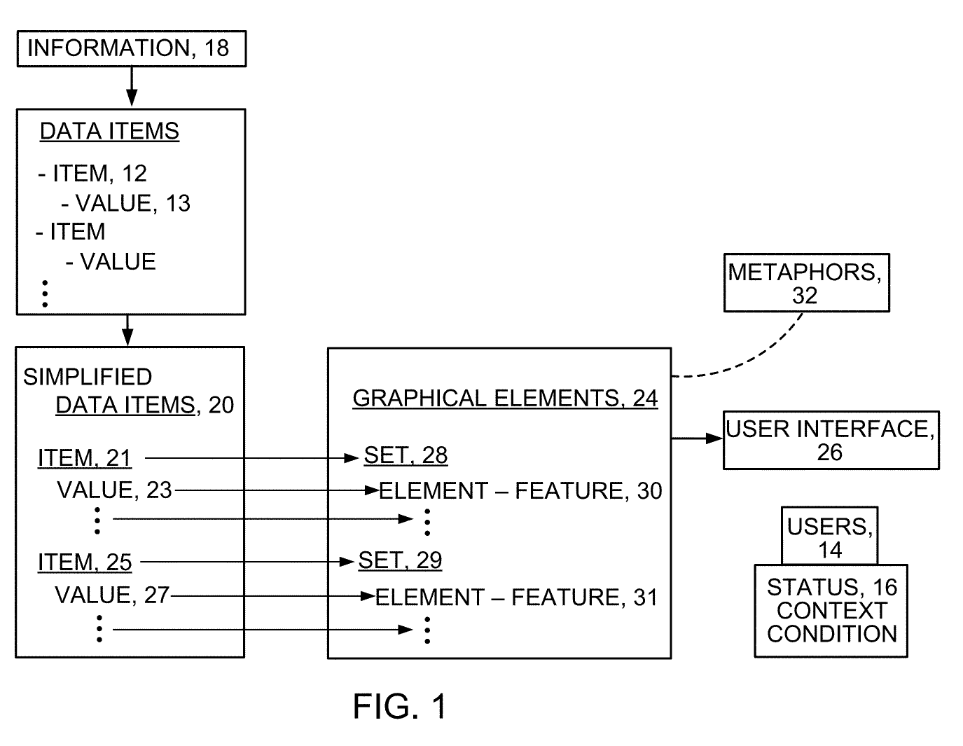

FIG. 1 is a block diagram of a visualization technology.

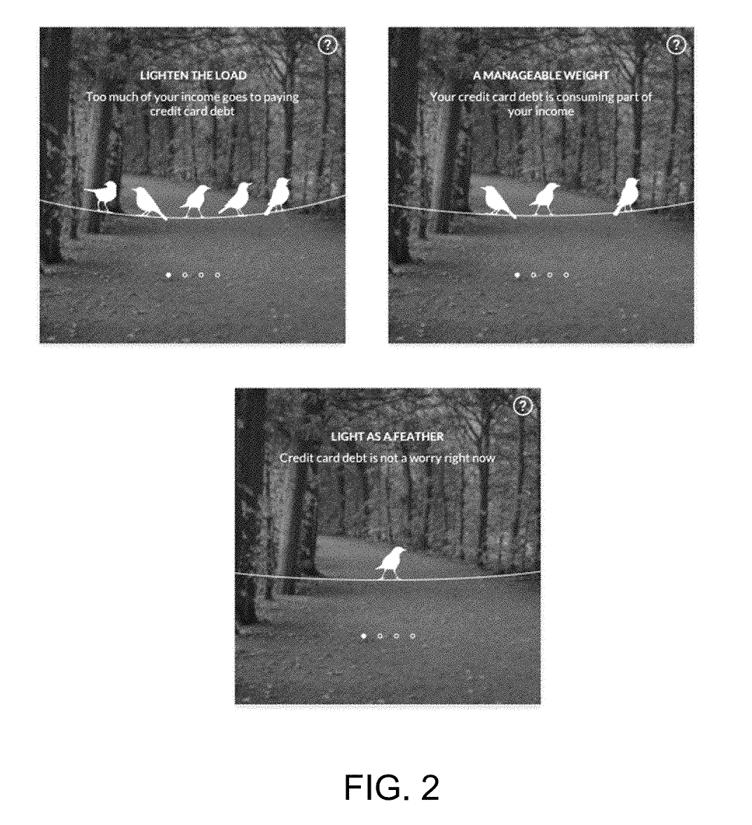

FIGS. 2 through 5 show metaphorical graphical elements.

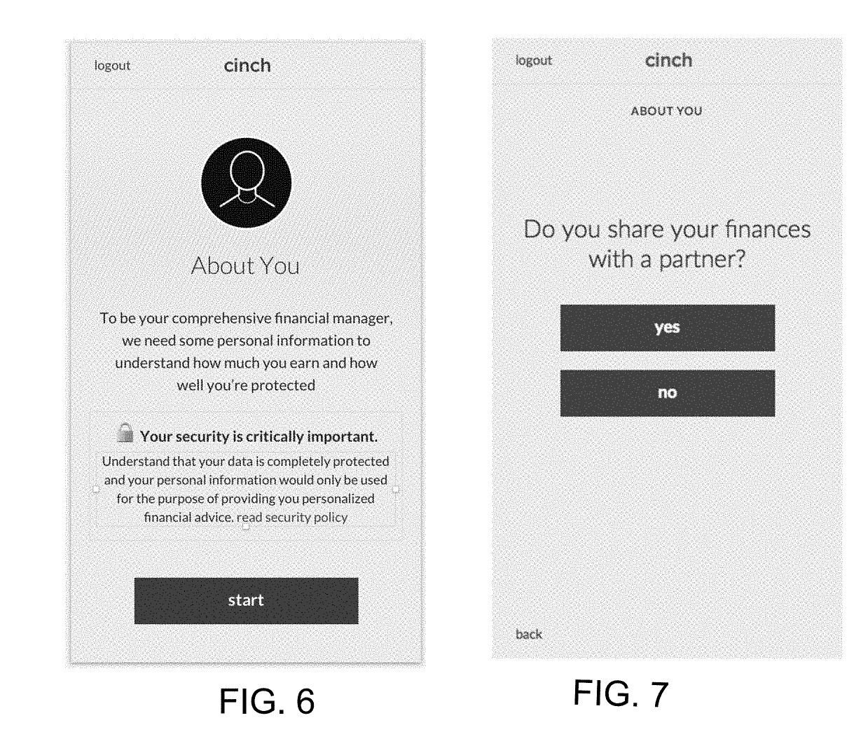

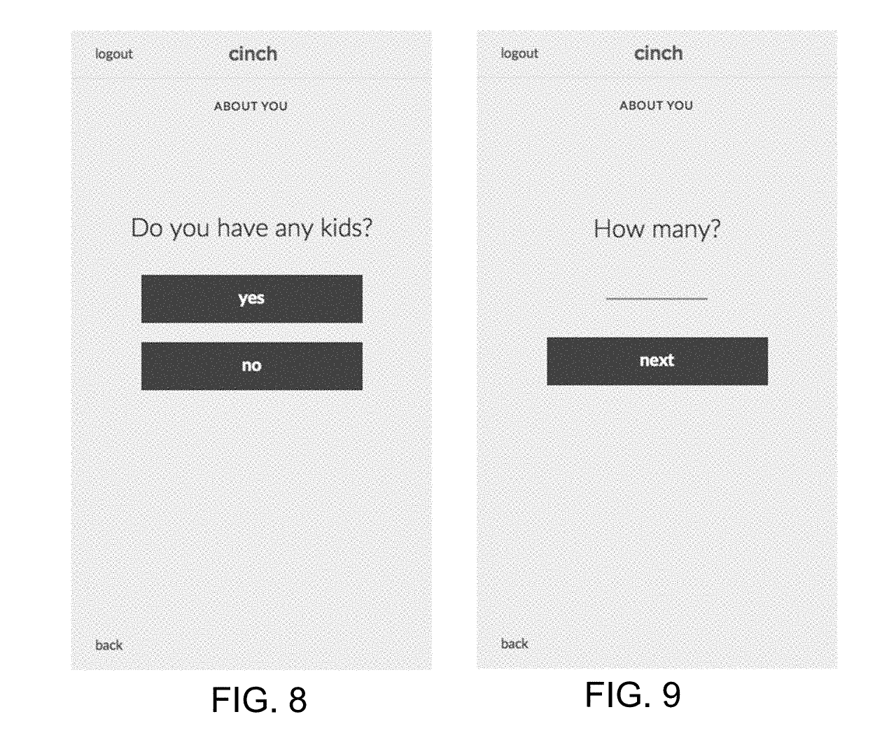

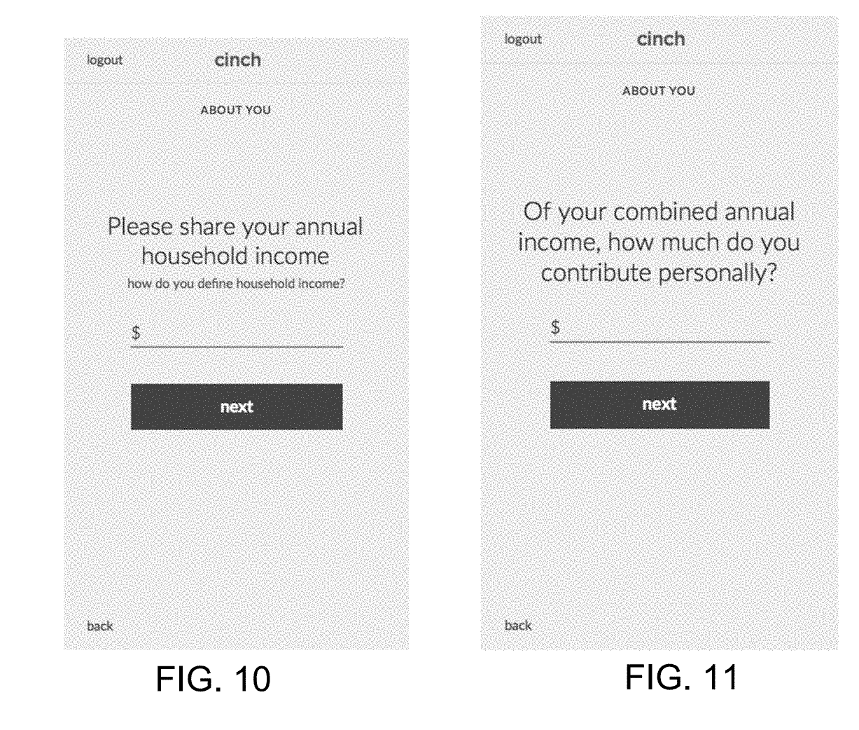

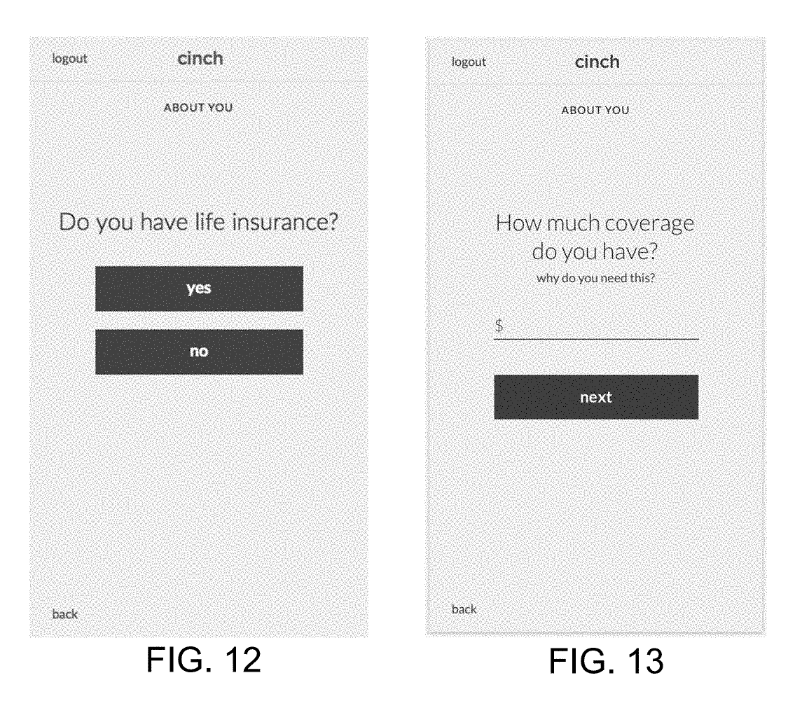

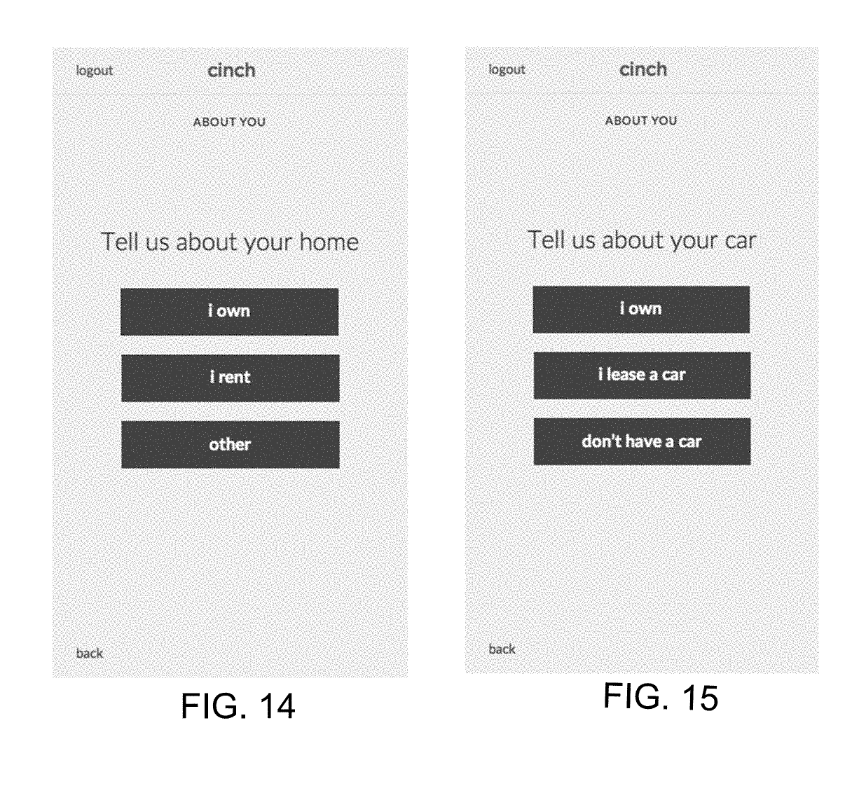

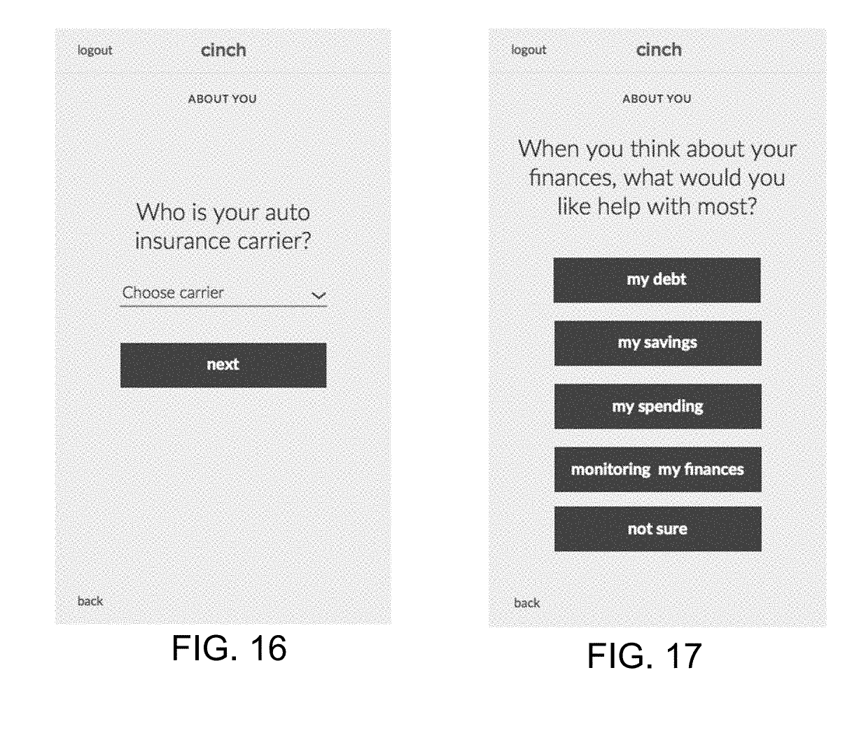

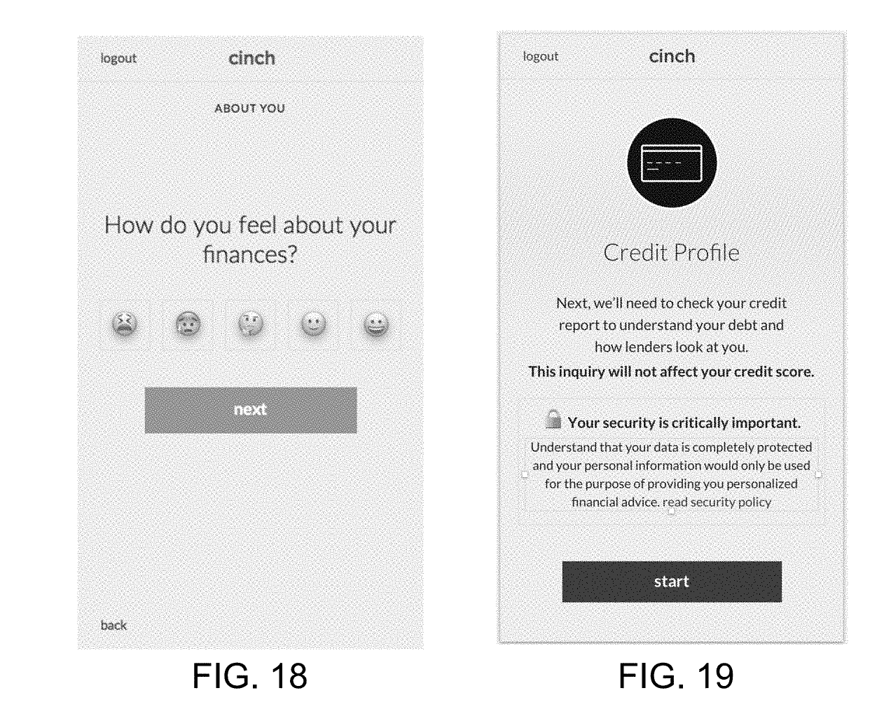

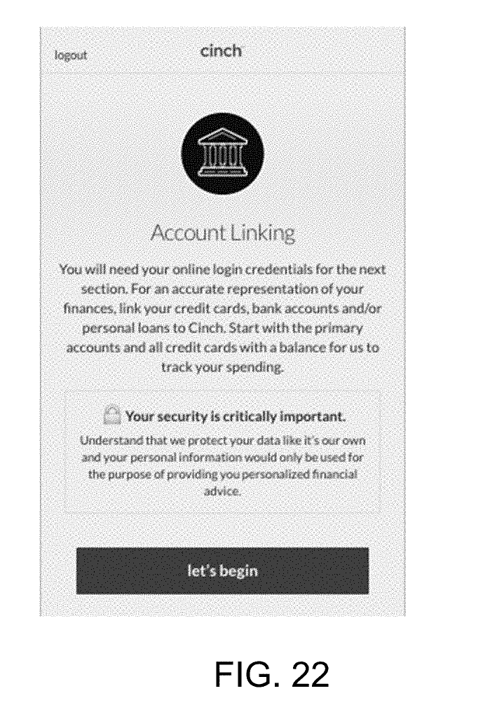

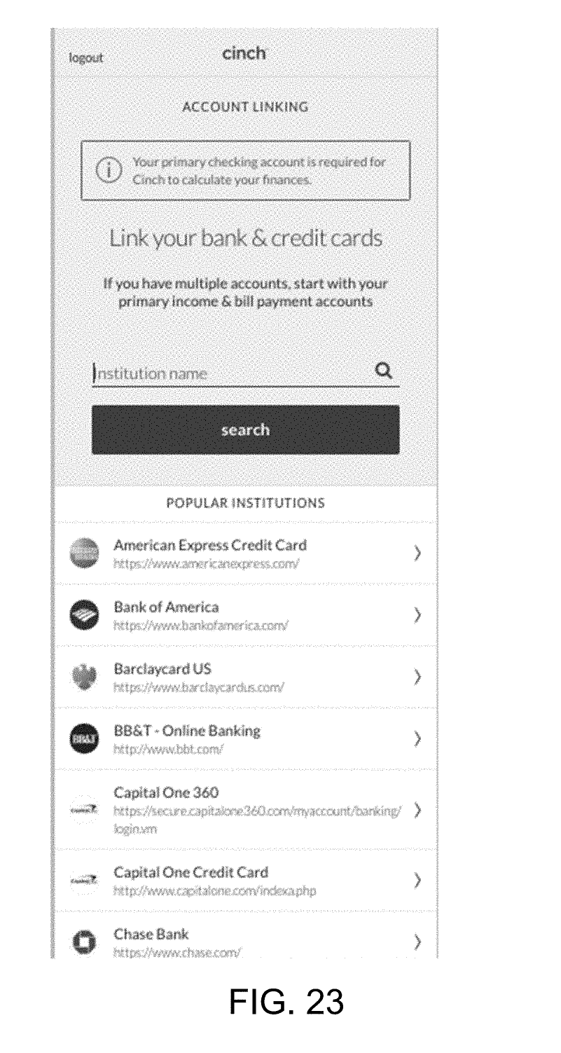

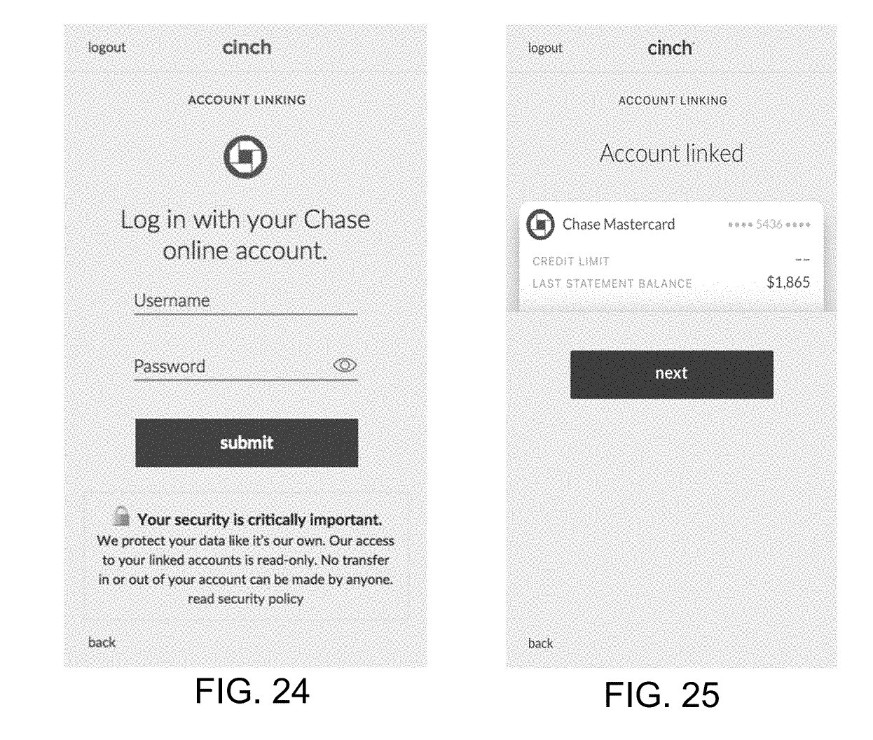

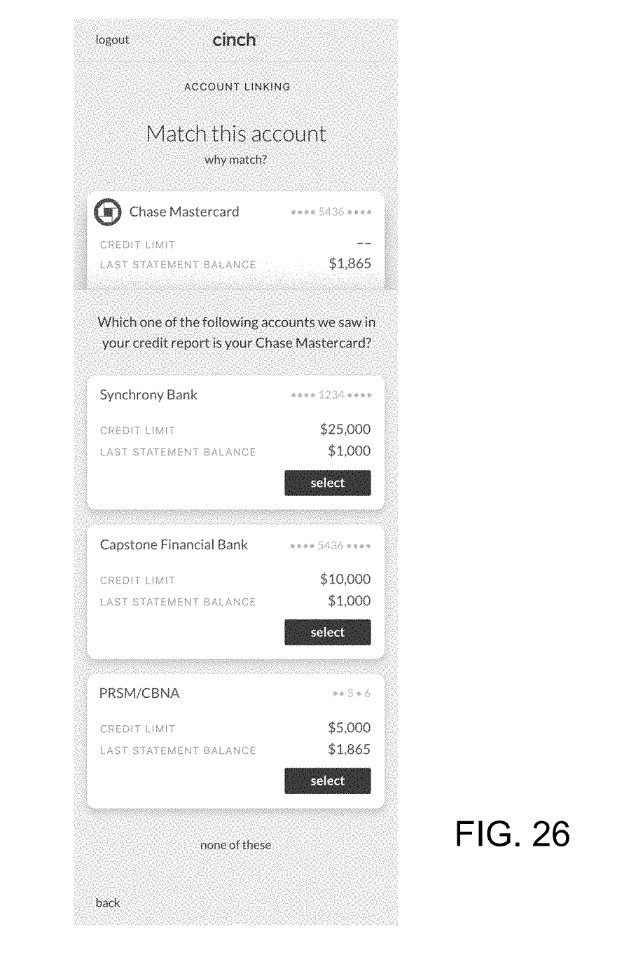

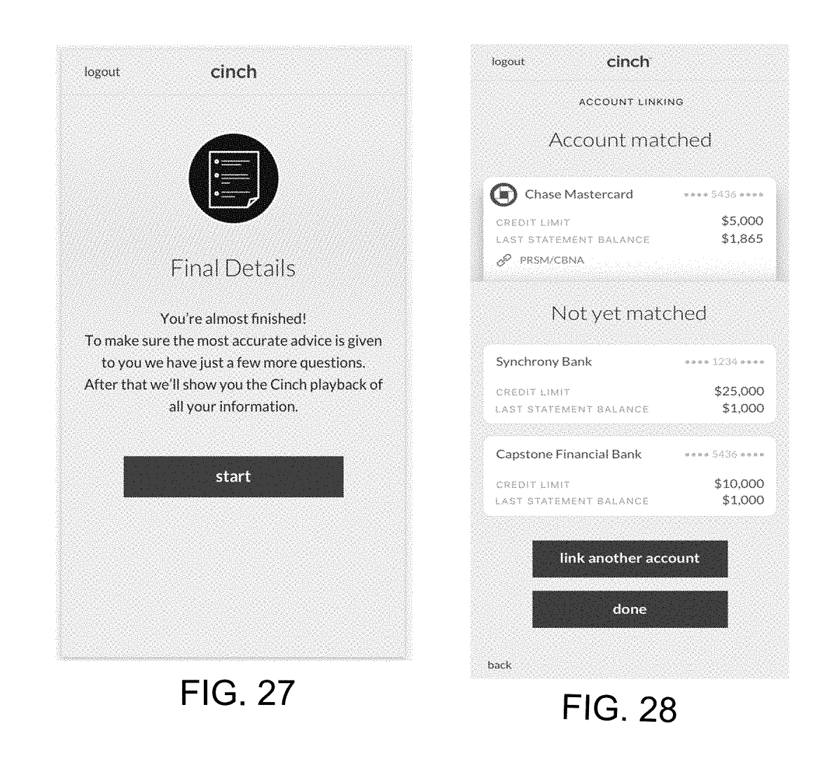

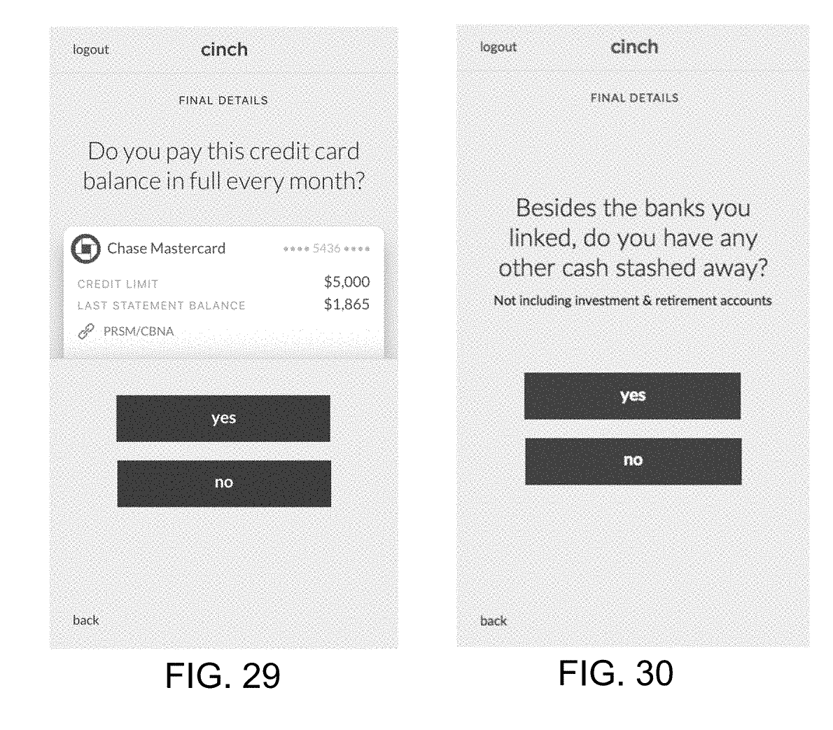

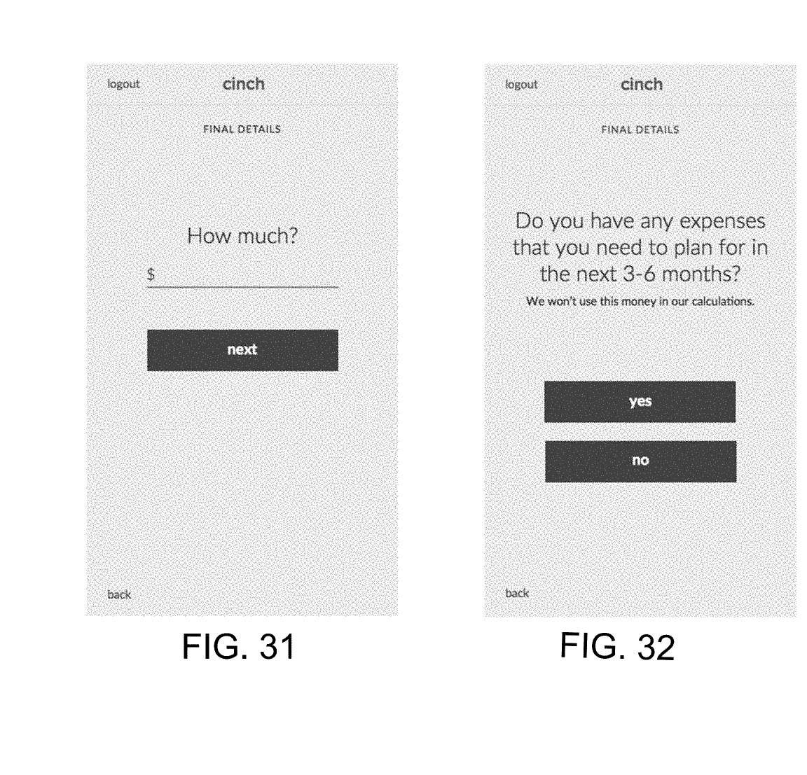

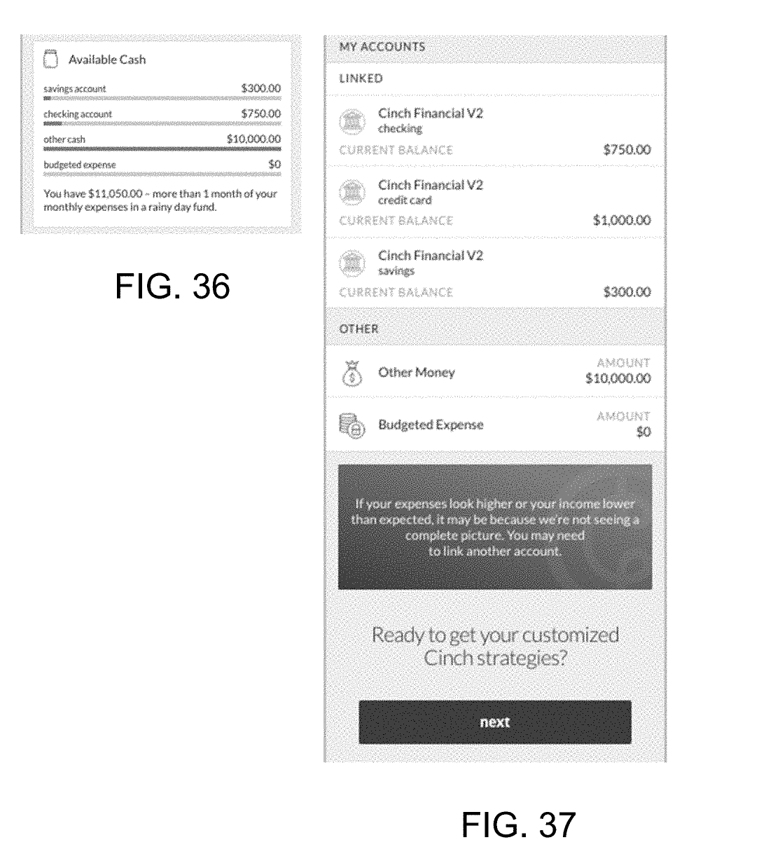

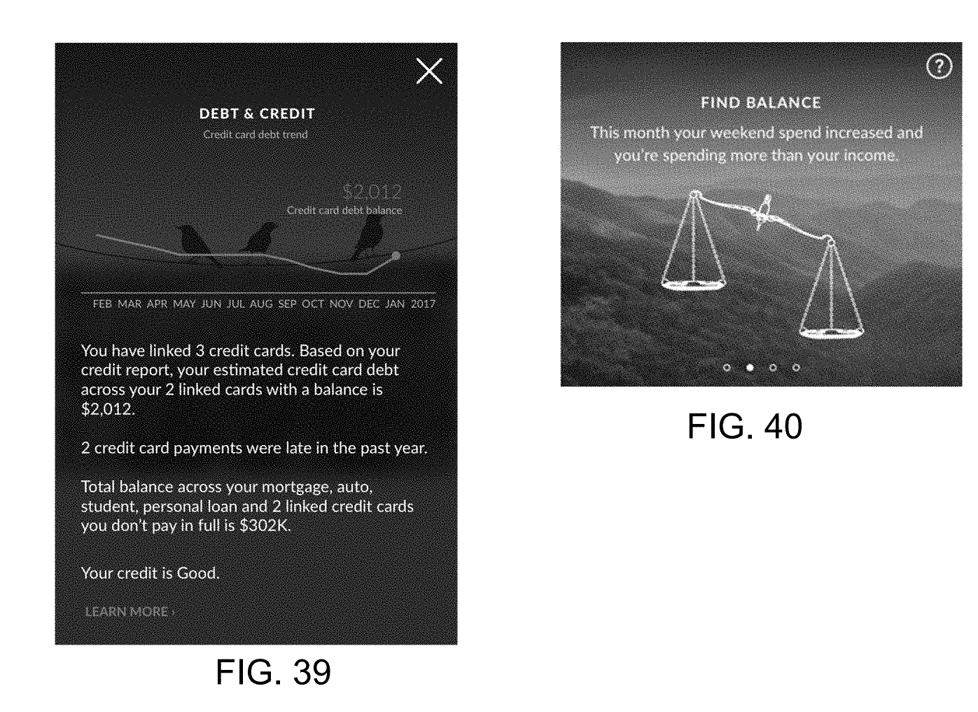

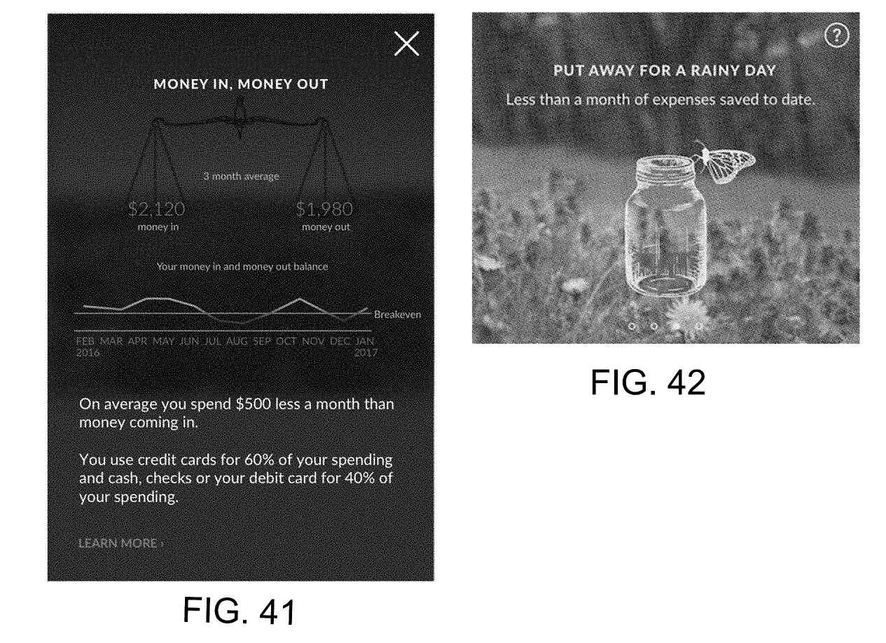

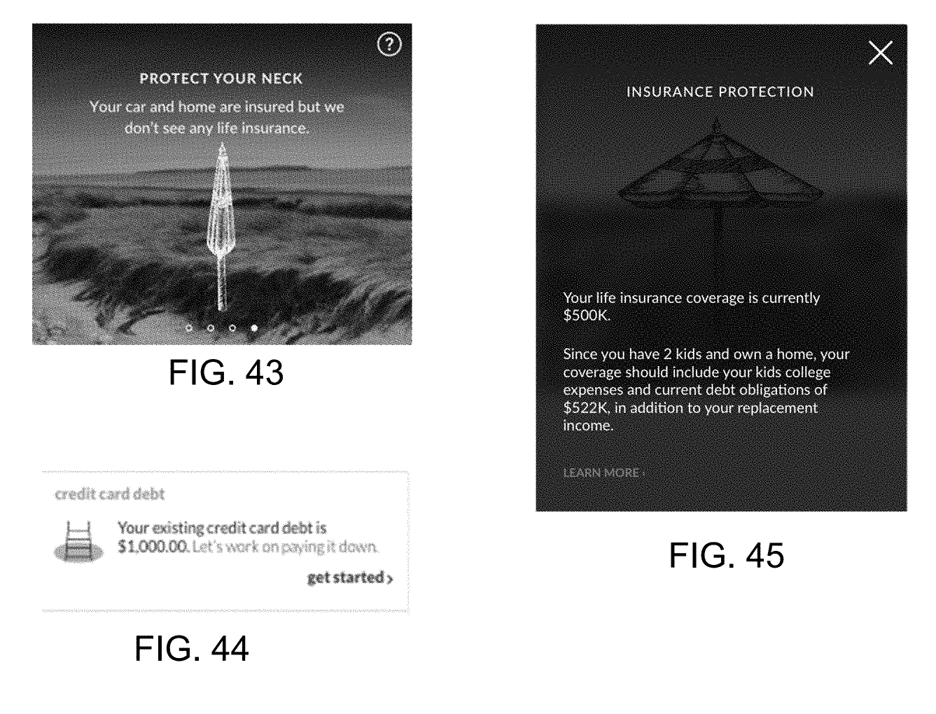

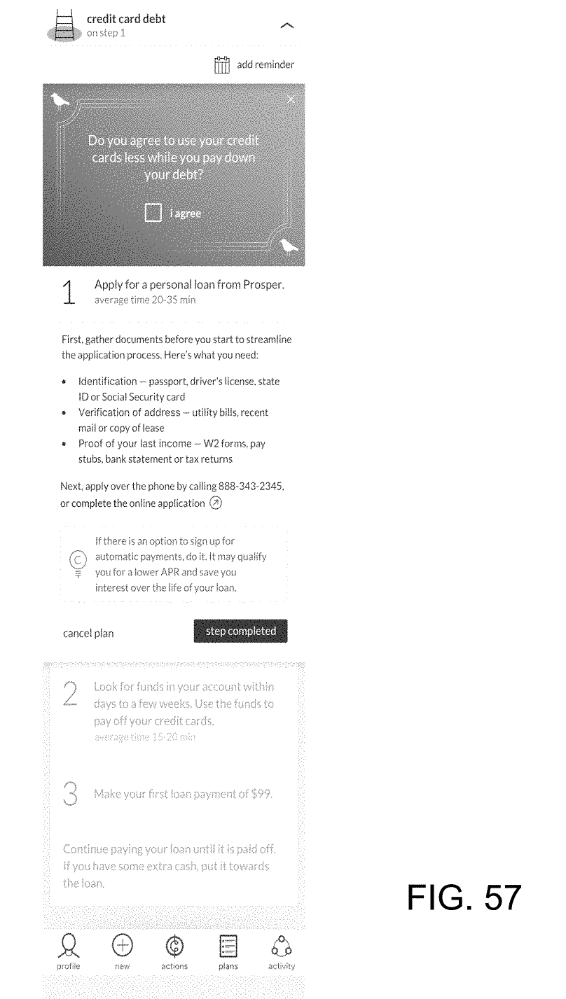

FIGS. 6 through 60 are screenshots.

As shown in FIG. 1, implementations of a technology 10 that we describe here can simplify and make more effective the presentation of (changing) values 13 of one or more data items 12 to users 14 who each are characterized by one or more statuses, contexts, or other conditions 16 that correspond to the values of the data items.

In some implementations, the statuses, contexts, or other conditions relate to financial circumstances of a user, for example an overall credit card balance condition of the user. Such a financial circumstance can correspond to a data item 12 that is calculated from financial and other information 18 obtained from various sources. For example, the financial and other information 18 could include information about credit card accounts of a user, and the related data item 12 could be a value 13 calculated from the information 18 and representing an overall credit card balance condition of the user. Information about how such a calculation could be done can be found in U.S. patent application Ser. No. 15/593,870, filed on May 12, 2017, and incorporated here by reference.

The calculated values 13 of the data items 12 may be complex, voluminous, dynamic, and in other ways difficult for the user to understand and analyze if they were presented in a raw state, for example, as numbers in a large table on a user interface. For instance, for a particular data item 12 related to the credit card balance condition, calculated values could range from an arbitrary integer 1 to an arbitrary integer 99. In addition, for a given user, there may be a number of different financial conditions represented by different data items 12 and each of those data items may have calculated values that range in a fine-grained way continuously within broad arbitrary ranges. Presenting fine-grained values of multiple such financial conditions as numbers on a user interface can confuse or frustrate the user.

In examples of the technology that we describe here, the potentially complex, voluminous, and dynamic data items 12 are simplified into less complicated (e.g., simplified) data items 20. Each of the data items 21, 25 can be characterized by, for example, a small number of different values 23. For example, a simplified data item 21 corresponding to data item 12 may have only, say, three different values. For instance, the simplified data item 21 may represent a simplified version of the credit card balance condition of the user. Such a data item 21 could have one value indicating a poor credit card balance condition, a second value indicating a moderate credit card balance condition, and a third value indicating a good credit card balance condition. Each of the three values of the simplified data item 21 could correspond to a sub-range of 33 integers of the 99 possible calculated integer values of the underlying data item 12. In other words, the three possible values for the data item 21 are a simplified (much less fine-grained) set corresponding to a much more fine-grained set of 99 values of the underlying data item 12.

Each of the simplified data items 21 can be mapped 22, 39 to a corresponding set 28, 29 of easy-to-grasp graphical elements 24 to be presented to the user through a user interface 26 of a web browser or a mobile or other application. For example, the simplified data item 21 relating to the credit card balance condition can be mapped to a set 28 of graphical elements used to represent that credit card balance condition.

Within each of the sets 28, 29, the graphical elements can be largely similar (including shared features) and can have one or more particular features 30, 31 that differ from graphical element to graphical element within the set. The differences in the graphical presentation of a particular feature 30, 31 from graphical element to graphical element within the set are representative of differences in (and changes in) the values of the simplified data item 20 with which the set corresponds. As the value of the simplified data item 20 changes over time, the different graphical elements of the set that correspond to the small number of different values can be presented to the user through the user interface as simplified, easy-to-grasp dynamic representations of the values and changes in the values of the data items.

In the example of the data item 21 relating to credit card balance condition, there can be three different graphical elements in the set 28 and those graphical elements can share many features in common and have one or more graphical features in which they differ.

In some cases, the choices and designs of the graphical elements 24 and features such as features 30, 31 of each set 28, 29, are based on or take advantage of metaphors 32 that are well understood or can be quickly learned by users. Not only the individual graphical elements and their features, but also the relationships of individual graphical elements and their features within each set and the way they change in response to changes in the values of the corresponding data items can be metaphorical.

As illustrated in examples discussed below, the metaphors used in designing the graphical elements can be selected from metaphors commonly used and understood in a society or culture in which the user interface is to be presented.

Therefore, as we have explained, each data item 12 may be characterized by a large number of possible values 13. The granularity of those values is simplified by reducing their number two a much smaller number of values of the corresponding simplified data item 20. Each of the smaller number of values corresponds to one of the graphical elements 24 of the set 28, 29 that is tied to the item 21, 25. The number of graphical elements in a given set could, for example, be fewer than ten or fewer than five or as few as two. At a given time, one of the graphical elements of the set is used to represent the corresponding value of the underlying data item. As that corresponding value changes over time, the displayed graphical element also changes. This simplified visualization technique makes it much easier for the user to process and understand the data.

In some cases, the underlying data items relate to other financial conditions of a user, such as cash flow, available cash, credit balance, or insurance coverage, or combinations of them, among others.

The underlying data items 12 and their values 13 can be derived or calculated from a wide variety of detailed data drawn from a wide variety of sources. In some implementations, the underlying data items are produced by analytical and statistical analyses of the kind described in U.S. Pat. No. 9,704,107, incorporated here by reference.

FIGS. 2, 3, 4, and 5 each show a set of three metaphorical graphical elements for presentation on a user interface such as a smartphone screen. The metaphors used by each of the graphical elements in each set and for changes of the appearance of the graphical elements within the set are different in each of the four figures.

In the example of FIG. 2, the metaphor is of birds perching on a line supported at two ends. The curvature of the line changes as the number of birds perched on the line changes, to reflect the weight of the different numbers of birds. In the upper left-hand graphical element, for example, the line is pushed down farther than in the other two graphical elements by the weight of the five birds. For each of the three graphical elements in FIG. 2, the number of birds and the curvature of the line on which they perch are representative of a current amount of credit card debt of the user, that is, a credit card balance condition of the user.

In many cultures, debt is considered to “weigh on” the mind or psyche of the person who bears the debt. The metaphor of the weights of the birds and the curvature of the lines in which they perch corresponds to the varying weights of different credit card debt on the user's mind. The metaphorical graphical elements are easier for the user to understand and internalize than numerical values would be. In addition, rather than presenting to the user a fine-grained value (such as dollars and cents) of credit card debt, either numerically or through a very large number of corresponding graphical elements in a set, the number of graphical elements (three) in the set shown in FIG. 2 is deliberately kept small to simplify the presentation and make it easier for the user to understand. The implicit message being sent by each of the metaphorical graphical elements to the user is essentially “as a gentle reminder, your financial situation is being weighed down by credit card debt of, broadly speaking, the amount implied by the number of birds in the curvature of the line in this graphical element.”

As the user's credit card debt changes from one category to another, the technology changes the presentation to the user so that a different one of the graphical elements is presented. The change in the visualization between the two graphical elements is itself metaphorically representative of that credit card debt change. As the credit card debt decreases, for example, the number of birds and the curvature of the line change to imply metaphorically to the user that some of the psychological weight on her has been lifted (or added).

The implicit message provided by the graphical elements is reinforced by text messages shown at the top of each graphical element, such as “lighten the load; too much of your income goes to paying credit card debt.”

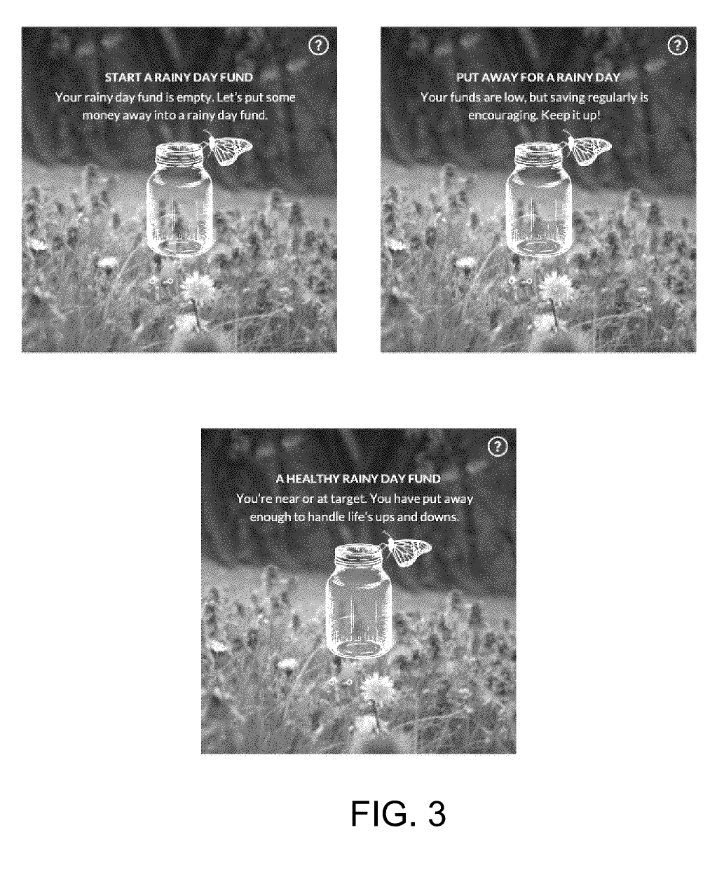

Other examples are presented in FIGS. 3, 4, and 5.

In FIG. 3, the financial condition being represented by the three graphical elements is the amount of cash currently available to the user, e.g., in savings. The metaphorical graphical elements include ajar and a butterfly that appear identically in all three (in other words, they share many common graphical features) except that different amounts of water accumulated in the jar correspond to different amounts of available cash. This arrangement corresponds to the metaphor used in some societies of a “rainy day fund” in which the amount of water represents the amount of cash available to be used in the case of an unexpected expensive event.

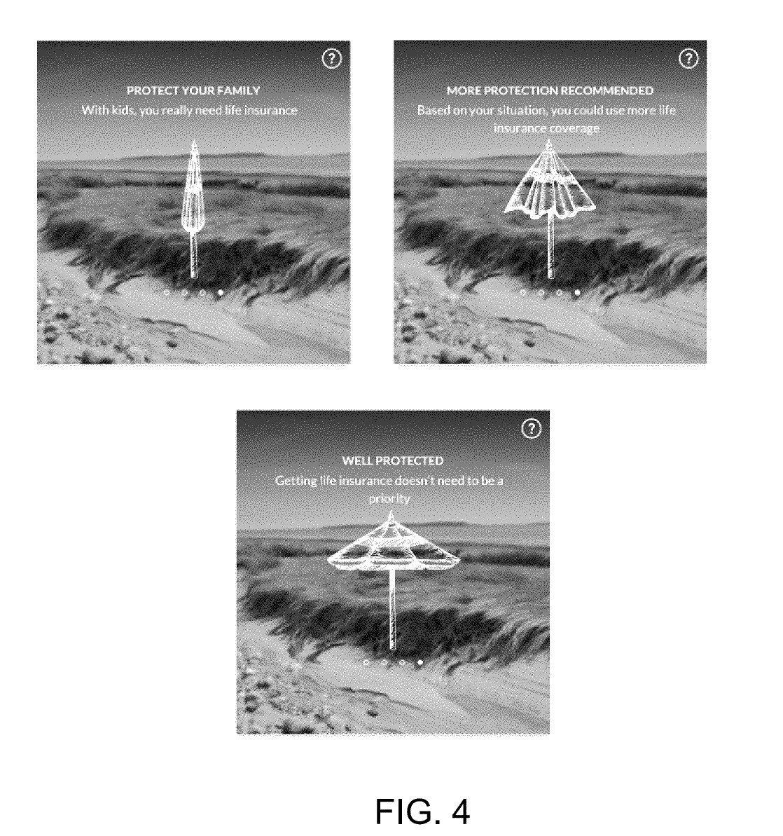

In FIG. 4, the metaphor is expressed by a cocktail umbrella in different states of being opened or closed. In some cultures, a cocktail umbrella is viewed as a protective device by analogy to its use to protect the user from rain or sun. Insurance is also viewed as a protective device, a financial one. By associating possible values of the simplified data items, which capture the amount or appropriateness of insurance held by the user, with one of the three deployment states of the cocktail umbrella, the technology is able to present the state of insurance protection to the user in a simple easy-to-understand visualization.

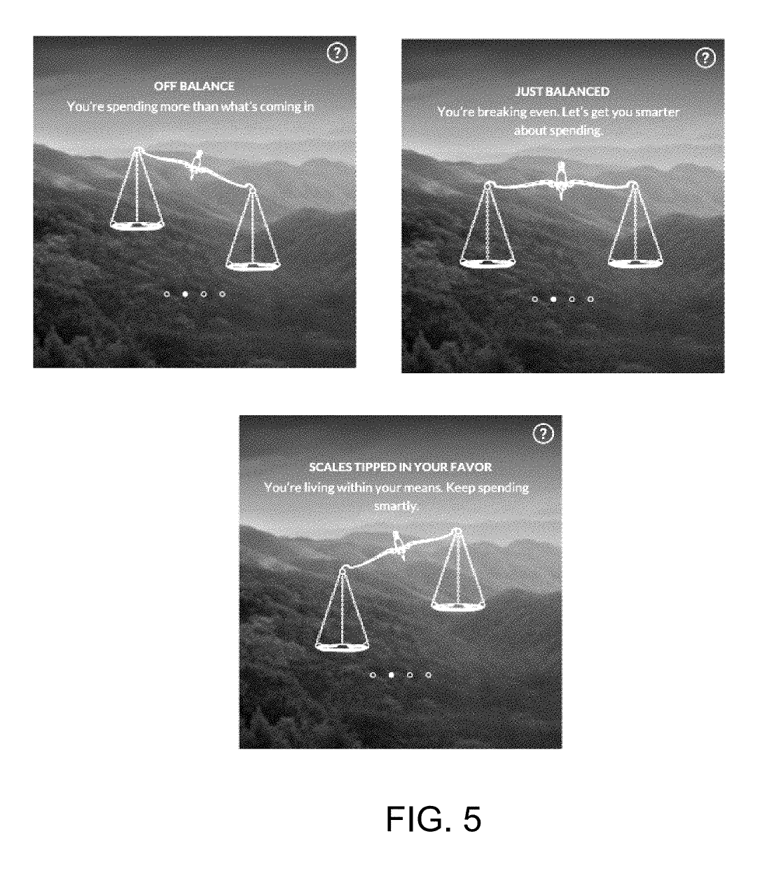

FIG. 5 illustrates the use of a metaphor associated with a balance arm as a way to present to the user the state of the user's cash flow position. For example, showing the balance arm in the state illustrated in the upper left graphical element implies to the user that she is spending more than she is taking him (negative cash flow).

The metaphorical graphical elements that we have discussed can be part of a complete series of user interface displays as part of a system that provides guidance to the user about her financial situation. Such a series of screens is shown in FIGS. 6 through 60.

As shown in FIGS. 6 through 18, part of the process implemented by the series of screens are steps of requesting information from the user about her financial and related life circumstances.

The questions are specifically chosen to provide capture information needed to make an initial financial assessment while building trust and a relationship with the user. Questions are presented in such a way as to cast the presenter of the questions as a trusted advisor to the user.

All data captured during this process is stored in a user profile. Stored information is used in computational models for a variety of purposes including to determine if there are areas where more questions need to be asked, or to present advice to the user directly.

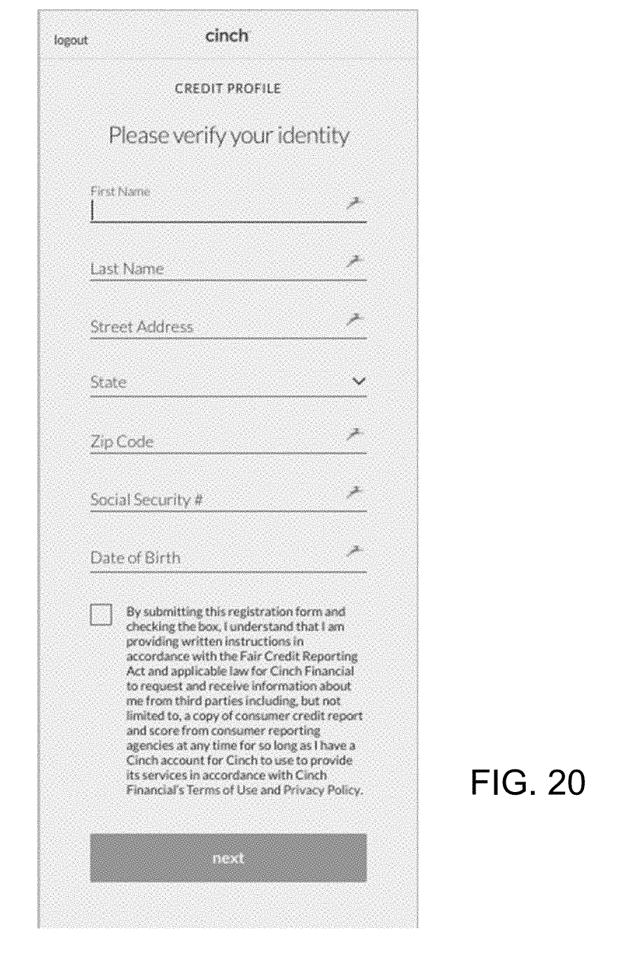

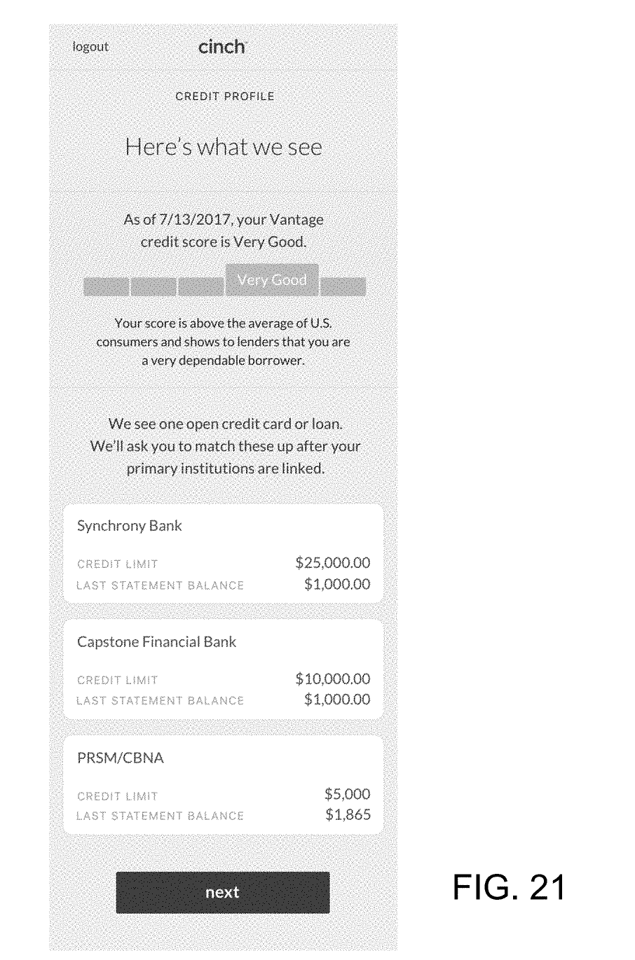

FIGS. 19 through 29 shows screens that involve interaction with the user with respect to her credit accounts. In FIGS. 19 and 20, the technology captures from the user information necessary to log into a credit report service and acquire information about credit card accounts of the user. FIGS. 21 through 28 involve engaging the user's help in matching the credit card accounts reported from the credit report service with credit card accounts for which information is separately obtained from financial institutions with which the user deals. Additional information about the steps of FIGS. 21 through 28 can be found in another U.S. patent application, titled Matching Accounts Identified in Two Different Sources of Account Data, filed on the same day as this application.

Although the technology that we are describing consumes the full credit report once it has been successfully retrieved, the screens display only selected details from the credit report to the user. The user can use these details to familiarize herself with details from her credit report. For a user who is more familiar with her report, this is an opportunity for her to recognize her own details within the mobile app.

This account information from the financial institutions with which the user deals serve as a second data source available to the technology.

For any credit cards that the user links, the technology requires the user to match the linked credit card account with the associated account from her credit report. The technology needs to associate these accounts so details are not double counted in the technology's calculations.

As shown in FIGS. 30 through 32, the user may be required to answer additional questions to complete her initial financial profile. These questions may include additional account level details that are needed or missing from her credit profile or linked accounts (e.g. missing APR or account pay in full status) and other questions that increase the technology's depth of understanding of the user's financial situation (e.g., other money or planned future expenses that the technology should know about).

The information users are required to provide about accounts is a runtime determination based upon what information has been provided from primary data sources (e.g., account linking and the credit report). If information available from those sources is ‘complete’ relative to the user's situation, the user would not be asked additional questions. But if, for example, neither source knew whether an account is paid off each month and the technology required that information, the system would determine it needs to obtain that from the user and prompt her with a question.

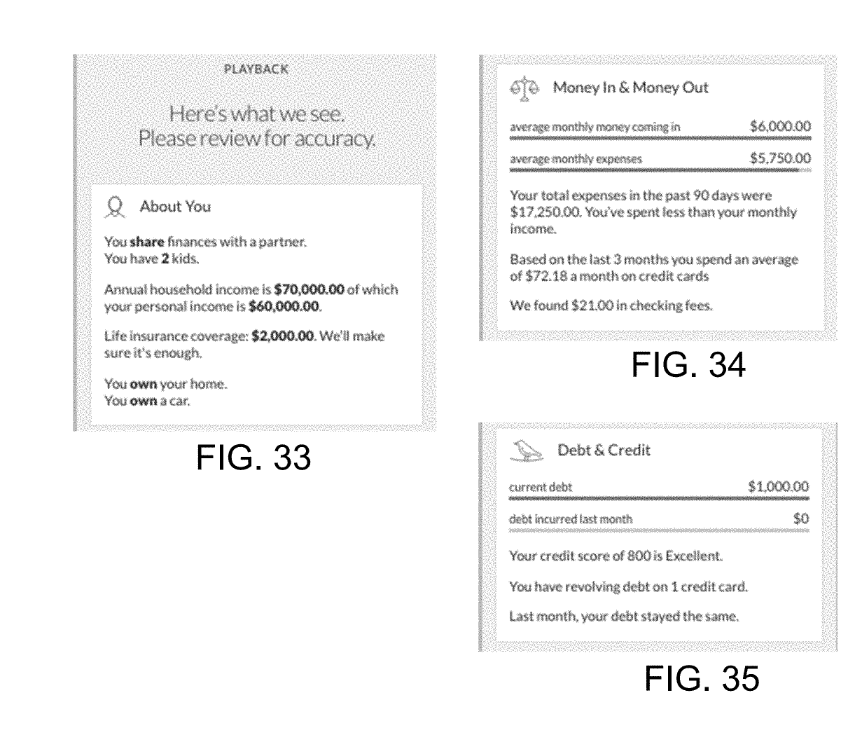

After the additional information is acquired, the technology “plays back” the financial profile created as a result of the information provided by the user. This is illustrated in FIGS. 33 through 37. The information includes answers that the user provided as well as accounts she linked. The details displayed are a combination of direct playback of what the user reported as well as values that are calculated by the technology.

This is an important step in the trust-building process with the user. The user must recognize herself in the playback in order to trust the forthcoming advice from the technology. The user has the opportunity to edit any of their responses or link additional accounts to ensure that the technology has a robust view of her financial situation.

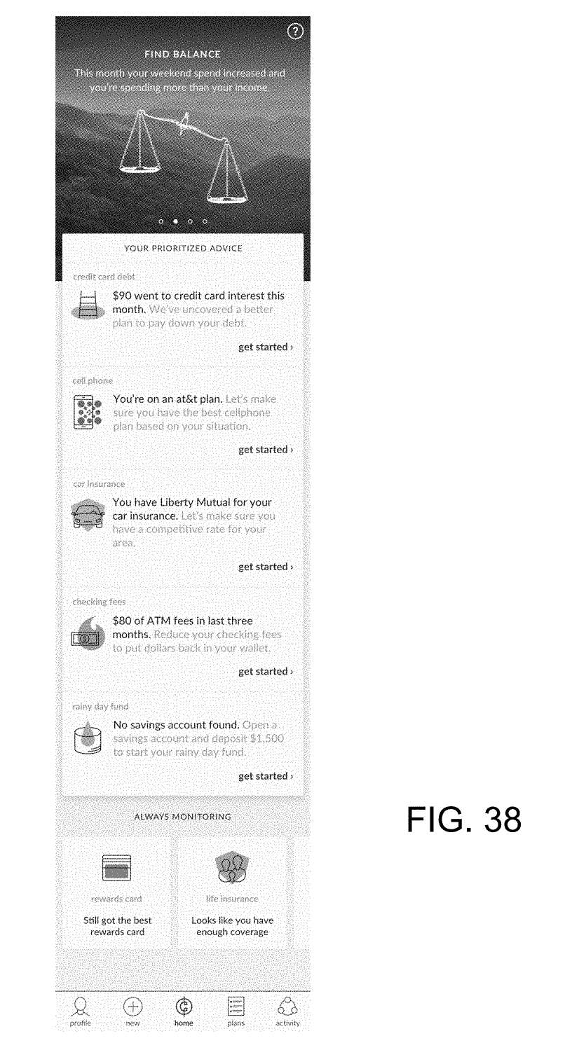

FIGS. 38 through 44 illustrate a dashboard that serves as the user's home base. The dashboard includes a hero panel which defaults to the user's top priority category (one of four financial categories), the list of prioritized advice that technology has based on the user's financial profile, an Always Monitoring section communicating areas of the user's life the technology is keeping an eye on, and a global navigation that takes the user to her profile or any active Action Plans.

The dashboard has four panels showing categories of information, one of which is the default panel associated with the user's top priority category of interest. Each panel represents a category in the user's financial life (as explained below). The user can navigate among the categories by using the dot navigation but the panels will always default to their top priority based on their assessment.

The technology categorizes the user's financial life into four main categories: Credit & Debt, Money In & Money Out, Available Cash, and Protection.

Each category is represented by an illustration that ties directly to the assessment metrics calculated by the technology. The illustrations change over time and will animate as the user makes progress or falls behind in her financial life.

Each category also has a ‘backstory’ when the user flips the panel over. The Backstory includes details of the current category status, both narrative details as well as data visualizations. The Backstory is an example for the user of the work and calculations that the technology has done and can also be a place where the user sees a more detailed snapshot of their category status.

Credit & Debt can provide a full picture of a user's debt situation and in some versions will focus on credit card debt. As explained earlier, Credit & Debt is represented by birds on a wire. A user with more credit card debt will have more birds on the wire. The wire will also visually change with the weight of the birds. As a user decreases her credit card debt and she updated to a new assessment level, the birds will animate and fly away and the wire will become less burdened.

Although we have previously described only the shifting from one to another of the graphical elements and static images, it is important to note that the changing from one image to another can be animated as in this example of one or more of the birds flying away. Similar animations can be provided for the other types of metaphorical presentations such as the ones discussed below.

Money In & Money Out captures the user's money inflows and outflows. It is represented by a scale. The scale tips to the left when the user's inflows exceed their outflows. The scale tips to the right if the user's outflows exceed their inflows. The scale is level if the user's inflows and outflows breakeven. As the user's situation changes and they move between the states, the scale will animate and change position accordingly.

Available Cash is representative of the user's cash liquidity, cash that is available after a user's monthly expenses. This is inclusive of existing savings but also includes cash that isn't currently in a savings account. This cash is considered when the technology is evaluating whether the user needs to/should increase her savings, pay off credit card debt or purchase life insurance.

Available Cash is represented by a Mason® Jar that fills with liquid as the user's liquidity increases and she reaches assessment milestones. The liquid and the butterfly on the side of the jar animate when a user reaches cash milestones—both when available cash increases or decreases.

Protection can encompass many forms of insurance and protection that impact the user's financial condition and in some implementations can focus solely on life insurance.

Protection is represented by an illustration of a cocktail umbrella. If the technology deems the user needs to have life insurance and she has an appropriate level of protection, or if she does not have a need for life insurance, the umbrella would be fully open. If the user has some level of protection but the technology deems that she needs additional coverage the umbrella is partially open. If the user does not have sufficient coverage (or no coverage at all), the umbrella will be closed. As the user meets different assessment milestones as her situation changes the umbrella will animate and open and close. In some implementations, the technology can assess a user's need for life insurance based on whether she has children of a certain age. If a user does not have any children the technology will not recommend that she needs coverage and the user will have a fully open umbrella.

For the list of prioritized advice that technology has based on the user's financial profile, an Always Monitoring section communicates what areas of the user's life technology is keeping an eye on, and provides a global navigation that the takes the user to her profile or any active Action Plans.

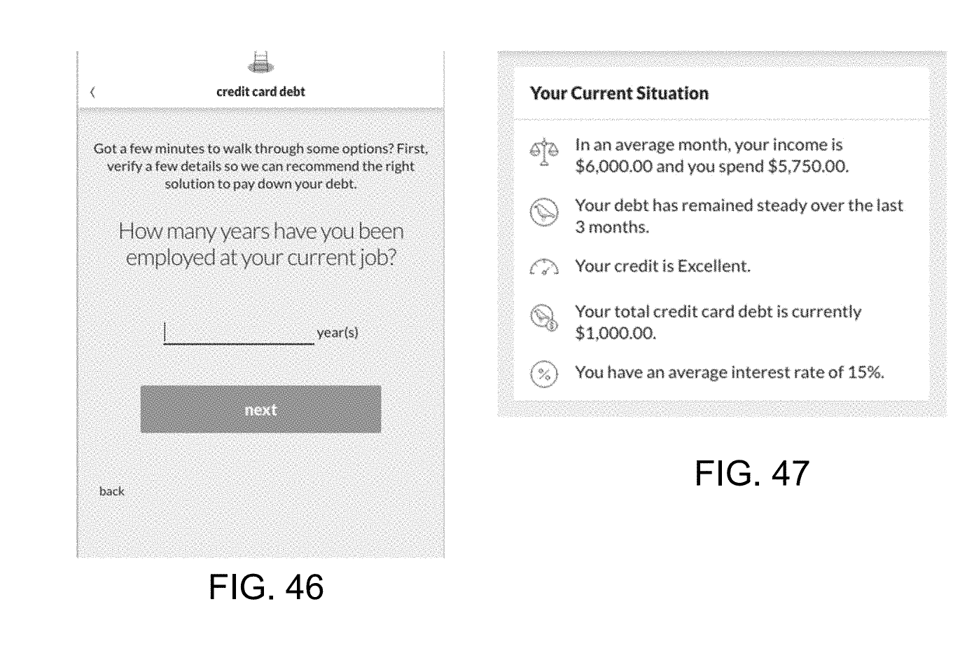

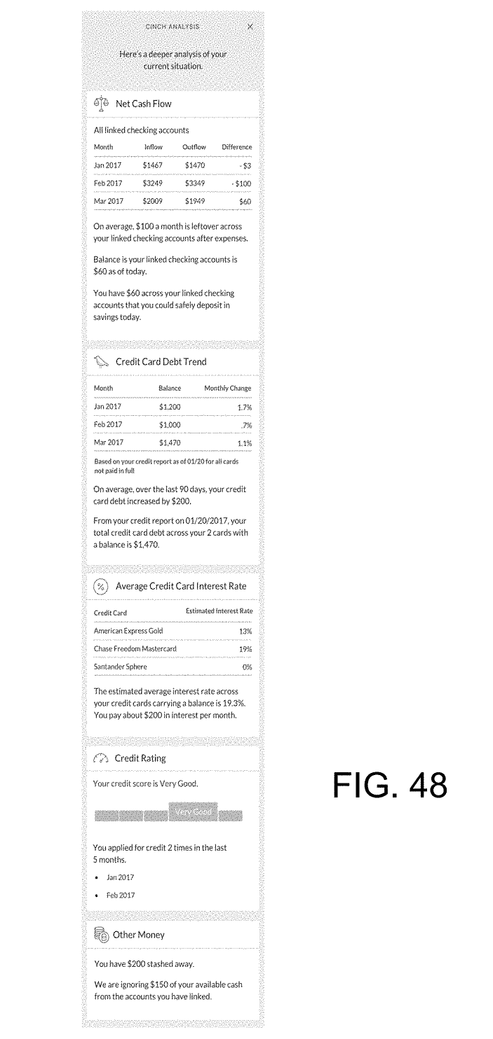

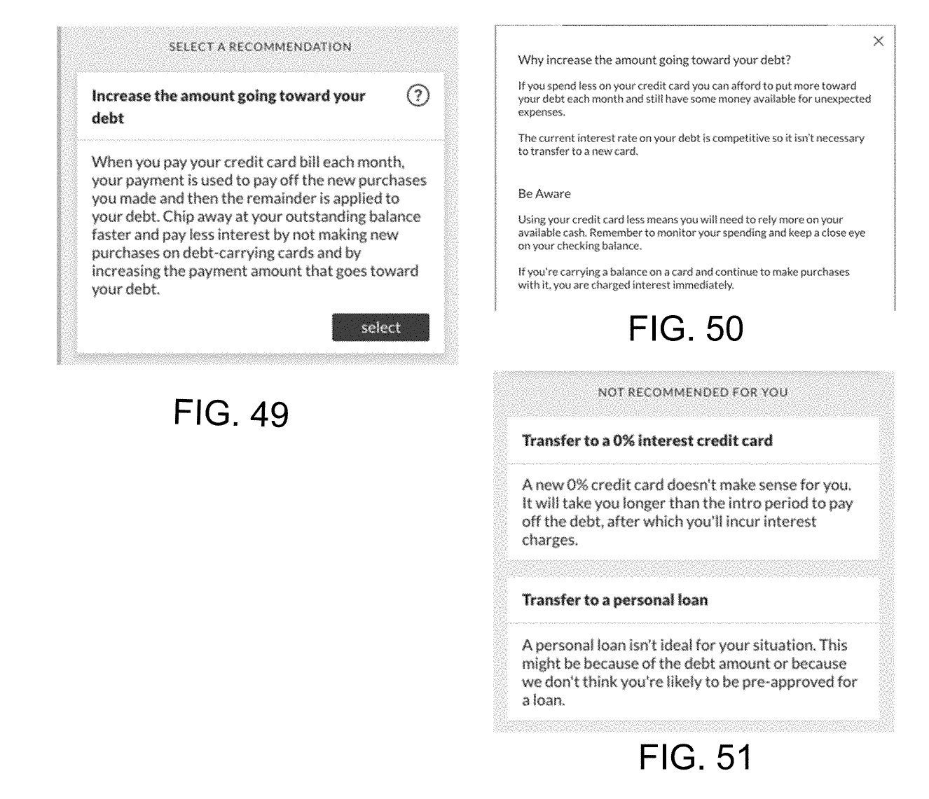

FIGS. 45 through 57 illustrate an interaction flow between the technology and the user with respect to the user's credit card debt. The technology maintains a list of prioritized advice cards for the user, one of which is shown in FIG. 45. Each advice card includes a personalized detail about the user's situation that is relevant to the advice category and a motivator for the user to explore further. If the user clicks on the get started link, the technology may require more information from the user to produce advice for that category. In these scenarios, additional questions will be asked until the system can produce a recommendation. FIG. 46 illustrates such a question. Once the technology has acquired all of the information it requires to produce a recommendation, it can present a screen, such as the one shown in FIG. 47, that summarizes details of the user's current financial situation that are relevant to the advice category. The technology also can provide a deeper analysis (FIG. 48) of the user's details relevant to the advice category. In this screen, the technology shares with the user the details that it looked at to understand the user's situation. This allows the user to recognize that the advice is pertinent to her situation. The technology can provide a specific recommendation to the user (FIG. 49), or a choice between two recommendations. Each recommendation includes an explanation of why the recommendation makes sense for the user. Details in the reason are based on the user's details. Some recommendation details are personalized.

Each recommendation includes additional details (FIG. 50, for example, which can be invoked by clicking on the question mark in FIG. 49) as to why the advice makes sense for the user. Included in this section are additional details the user should be aware of should they choose to follow the advice.

In providing advice, the technology assesses many possible recommendations. As shown in FIG. 51, the technology can present all of the details to the user so that they can make an informed decision. This includes, when applicable, displaying other actions that the technology reviewed and are not recommended for the user. Displaying advice that is not recommended maintains technology's unbiased and transparent image in the mind of the user.

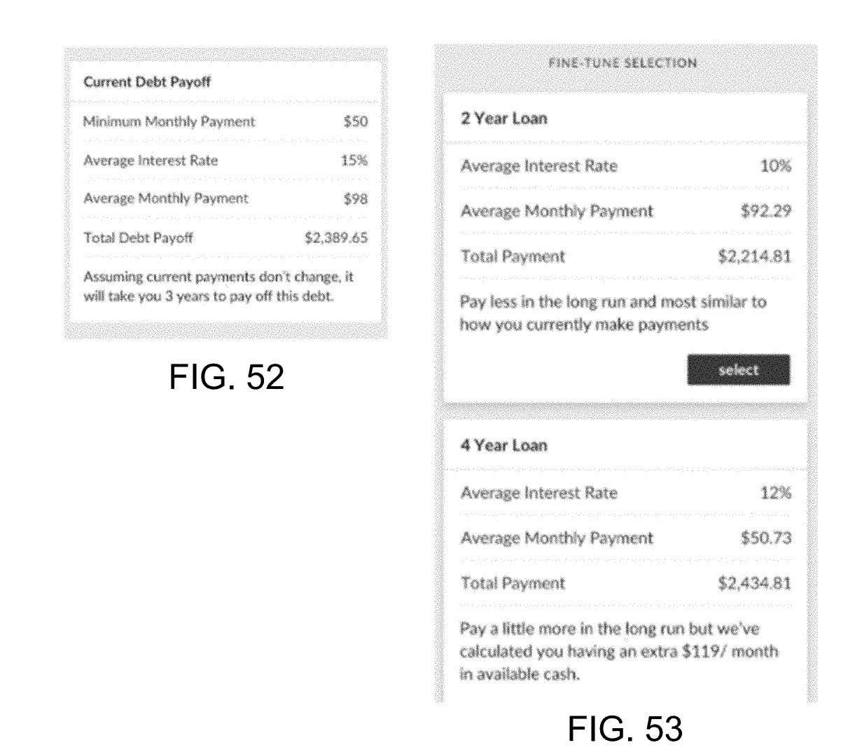

As shown in FIGS. 52 and 53, when applicable, the user will be presented with options to refine the recommendation provided by the technology. This step allows the user to participate in adjusting the advice to suit their needs. For example, choosing a payment speed from recommended options for paying off debt, or a coverage amount within a recommended range for life insurance. Specific details are provided on each option including how each option affects the user's situation.

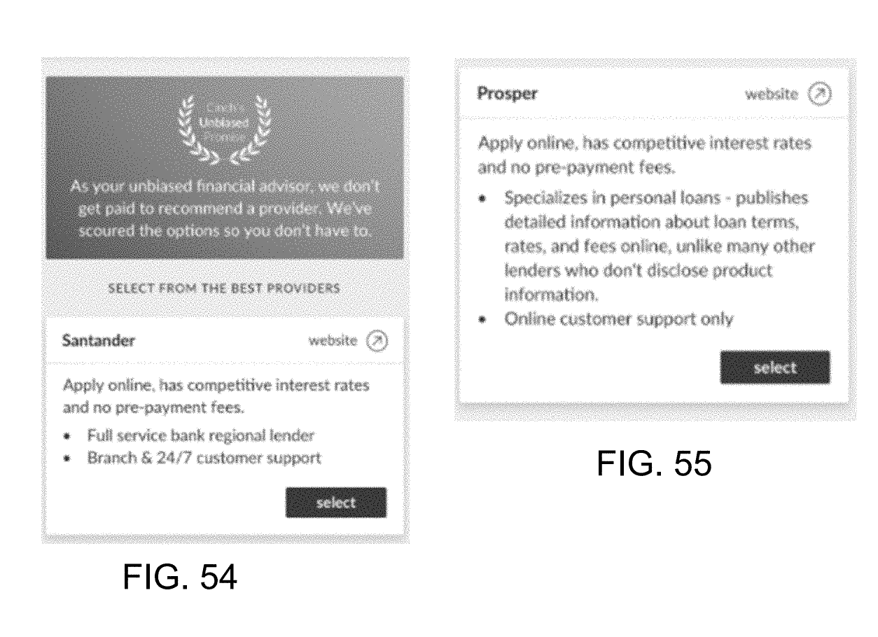

When a product or a provider is part of the recommendation, the user will be presented with at least two options (FIGS. 54 and 55). Specific details about each option are presented so the user can understand the features of a specific product or provider (e.g., credit card, loan provider, insurance provider, bank, etc.) Each option includes a link to the appropriate website so the user can do more research if interested.

Products and providers are presented without branding and in as uniform way as possible to guard against selection bias and in support of the user making a decision based solely on the features and benefits of each option.

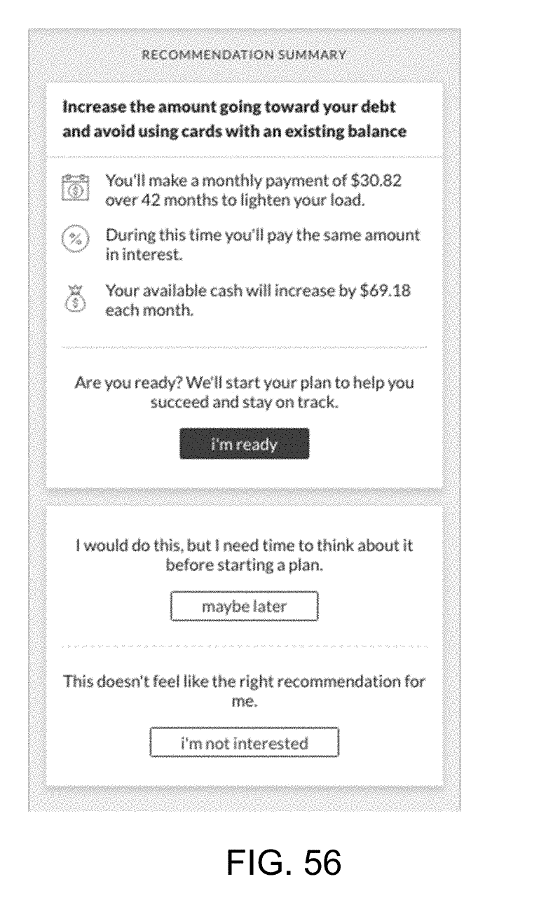

As shown in FIG. 56, the technology provides a recommendation summary once the user has made selections required as part of the recommendation decision making process. In the screen of FIG. 56, the specific choices the user has made are combined with both high level next steps and a summary of benefits to motivate the user to move forward.

The user has options at this point for specific actions: Get Started brings the user to the detailed Action Plan. Maybe Later allows the user some time to think and sets a reminder for the technology to check back with the user in a week. Not Interested allows the user to decline the recommendation and triggers the technology to keep looking for advice in the future.

The technology provides the user detailed step-by-step instructions on how to execute on the chosen recommendations. Each Action Plan starts with a social contract to reinforce the user being accountable for taking action to improve their financial situation. Each step includes details on what to do and what to expect, including estimated time to complete the task, when applicable. Steps may also include ‘Tips’, additional information on how to go above and beyond the required step, or hints and tips on how to make things easier.

Steps have calls to action for the user—both a positive and a negative (e.g. applied for the loan/not going to apply) so the technology can stay informed every step of the way. The technology will follow up with the user on their current status in the plan and remind them of next steps as they make progress.

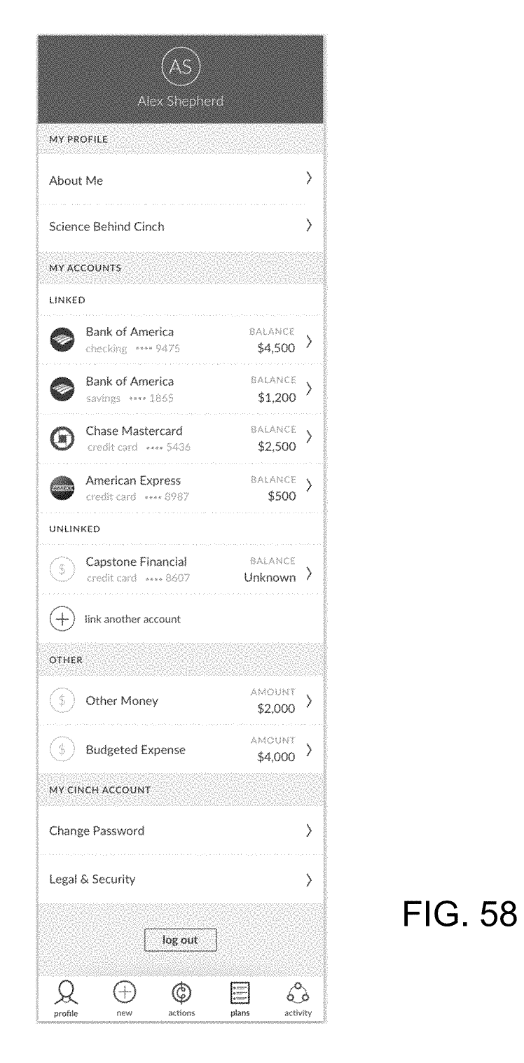

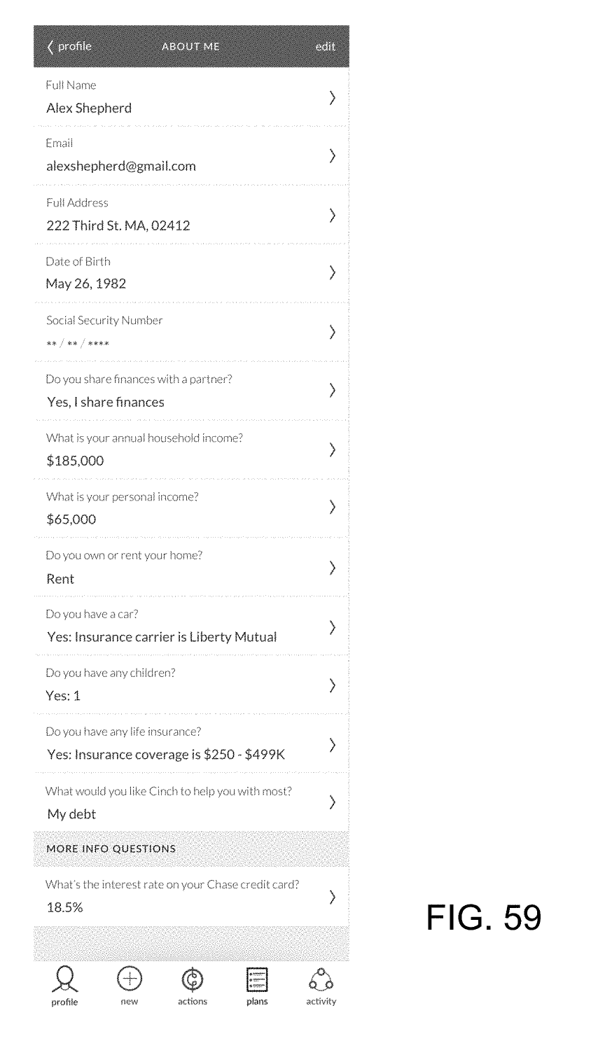

As shown in FIG. 58, a profile may be displayed where the user can access all of their account and personal information shared with the technology. From this screen, the user can link additional institutions, update linked accounts, edit any responses to questions presented during the account creation process or as part of the interaction represented by the other screens discussed earlier. Other profile information is shown in the screen of FIG. 59.

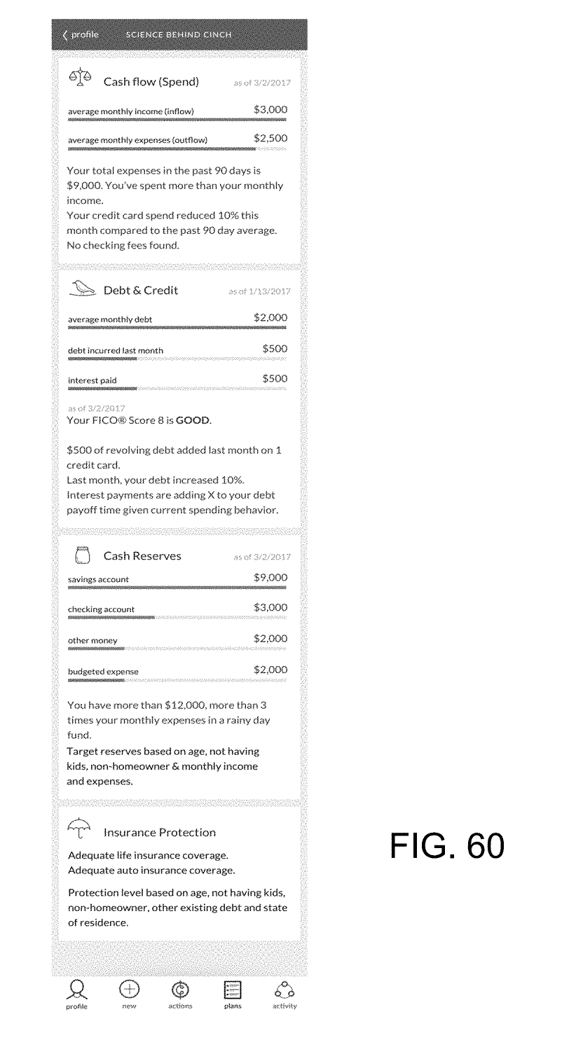

As shown in FIG. 60, as part of the user profile, the user can also access an even more robust playback of their financial life. This section will update over time once the user account is created. This is where the user can see their full current assessment.

At all times, it is useful to ensure that the user has a clear idea of what the technology is seeing and using as a foundation for the advice. This creates a partnership with the user so that they are empowered to see when their analyzed financial life may not fully align with their whole life and give them an opportunity to provide more detail to get the best advice from the technology.

Other implementations are within the scope of the following claims.

For example, although many of our examples have related to financial circumstances of the user, the technology that we have described can be applied to a wide range of circumstances other than financial to simplify presentation of underlying data items. For example, technology could apply to health data, weight loss data, or fitness data, among a wide variety of other applications.

In some cases, the metaphorical presentations can be sounds or video clips in addition to graphical elements, and combinations of them.

We have illustrated the technology by examples in which the graphical elements of a set may be stored and used as separate graphical elements each of which is displayed at an appropriate time and in which the graphical elements of the set share some features in common and have one or more distinct features not in common. In some implementations, similar effect can be produced by using a single stored graphical element and altering only the one or more distinctive features of the graphical element. Other approaches to presentation of the visualization are also possible.

1. A method comprising
deriving, from a value of an underlying data item having relatively more possible values, a value of a simplified data item having relatively fewer possible values, the possible values of the underlying data item numbering fewer than ten and corresponding to respective degrees of a user-related condition,
presenting to the user on an electronic user device a graphical metaphorical element that metaphorically represents one of the degrees of the user-related condition corresponding to the derived value of the simplified data item, the graphical metaphorical element comprising a representation of a real-world object in a particular state,
the graphical metaphorical element belonging to a set of graphical metaphorical elements that are graphically related, depict the real-world object in different respective states, the number of different graphical metaphorical elements corresponding to the number of possible values of the simplified data item, and metaphorically represent different respective degrees of the user-related condition,
deriving a new value of the simplified data item in response to a change in the user-related condition for the user, and
in response to the new value, presenting to the user on the electronic user device a different one of the graphical metaphorical elements of the set,
the change in the particular state of the depicted real-world object from one to the other of the metaphorical elements metaphorically representing the change in the user-related condition.

2. The method of claim 1 in which the user-related condition comprises a financial condition.

3. The method of claim 2 in which the financial condition comprises at least one of insurance protection, available cash, cash flow, or debt.

4. The method of claim 1 in which the number of possible values of the underlying data item is larger than the number of metaphorical elements.

5. The method of claim 1 comprising associating each of the metaphorical elements with a body of the possible values of the underlying data item.

6. The method of claim 1 comprising presenting to the user on the electronic user device simultaneously with the presentation of the graphical metaphorical element, a list of advice items related to the metaphorical element.

7. The method of claim 6 in which the list is presented in a prioritized order.

8. The method of claim 1 comprising presenting to the user on the electronic user device simultaneously with the presentation of the graphical metaphorical element, representations of elements that are being monitored continuously.

9. The method of claim 1 in which the graphical metaphorical object comprises at least one of a line hung between two supports, a cocktail umbrella, a balance scale, and a jar of water.

10. The method of claim 1 in which the different states of the depicted real-world object comprise at least one of different shapes of the object, different locations of the object, or different orientations of the object.

11. (canceled)

12. (canceled)

13. The method of claim 1 comprising animating the change in the particular state of the depicted real-world object from one to the other of the metaphorical elements.

14. An apparatus comprising
a processor configured to derive, from a value of an underlying data item having relatively more possible values, a value of a simplified data item having relatively fewer possible values, the possible values of the simplified data item numbering fewer than ten and corresponding to respective degrees of a user-related condition,
an electronic presenting device configured to present to the user a graphical metaphorical element that metaphorically represents one of the degrees of the user-related condition corresponding to the derived value of the simplified data item, the graphical metaphorical element comprising a representation of a real-world object in a particular state,
the graphical metaphorical element belonging to a set of graphical metaphorical elements that are graphically related, depict the real-world object in different respective states, the number of different graphical metaphorical elements corresponding to the number of possible values of the simplified data item, and metaphorically represent different respective degrees of the user-related condition,
the processor configured to derive a new value of the simplified data item in response to a change in the user-related condition for the user,
the presenting device configured to present to the user on the electronic presenting device a different one of the graphical metaphorical elements of the set,
the change in the particular state of the depicted real-world object from one to the other of the metaphorical elements metaphorically representing the change in the user-related condition.

15. The apparatus of claim 14 in which the user-related condition comprises a financial condition.

16. The apparatus of claim 15 in which the financial condition comprises at least one of insurance protection, available cash, cash flow, or debt.

17. The apparatus of claim 14 in which the number of possible values of the data item is larger than the number of metaphorical elements.

18. The apparatus of claim 14 comprising associating each of the metaphorical elements with a body of the possible values of the data item.

19. The apparatus of claim 14 in which the electronic presenting device is configured to present to the user on the electronic user device simultaneously with the presentation of the graphical metaphorical element, a list of advice items related to the metaphorical element.

20. The apparatus of claim 19 in which the list is presented in a prioritized order.

21. The apparatus of claim 14 in which the electronic presenting device is configured to present to the user on the electronic user device simultaneously with the presentation of the graphical metaphorical element, representations of elements that are being monitored continuously.

22. The apparatus of claim 14 in which the graphical metaphorical object comprises at least one of a line hung between two supports, a cocktail umbrella, a balance scale, and a jar of water.

23. The apparatus of claim 14 in which the different states of the depicted real-world object comprise at least one of different shapes of the object, different locations of the object, or different orientations of the object.

24. (canceled)

25. (canceled)

26. The apparatus of claim 14 comprising animating the change in the particular state of the depicted real-world object from one to the other of the metaphorical elements.
